(19) United States
(12) Patent Application Publication
(10) Pub. No.: US 2003/0187606 A1
(43) Pub. Date: Oct. 2, 2003

(54) Method and apparatus for a combustionless BTU measurement meter

(76) Inventor: Jimmie L. Curry, Allen, TX (US)

Correspondence Address: BROWN & MICHAELS, PC, 400 M & T BANK BUILDING, 118 NORTH TIOGA ST, ITHACA, NY, 14850, US

(21) Appl. No.: 10/313,461

(22) Filed: Dec. 5, 2002

Related U.S. Application Data
(60) Provisional application No. 60/341,167, filed on Dec. 13, 2001.

(51) Int. Cl. G01N 24/08

(52) U.S. Cl. 702/136; 73/25.01; 374/43; 324/307; 324/313

(57) ABSTRACT

A combustionless BTU meter utilizes Nuclear Magnetic Resonance (NMR) spectroscopy to measure the concentrations of the component parts of a heterogeneous gas. Measurement of the gas component concentrations allow for subsequent calculations of British Thermal Unit/Cubic Foot (BTU/CF) from the measured component parts. Static pressure and temperature are also measured. Gas concentrations are preferably combined with static pressure and temperature, to calculate other characteristics of British Thermal Unit/Pound (BTU/lb), molar mass, relative density, and absolute gas density. A method for measuring heat production is also disclosed.

### REFERENCE TO RELATED APPLICATIONS

This application claims an invention which was disclosed in Provisional Application No. 60/341,167, filed Dec. 13, 2001, entitled “METHOD AND APPARATUS FOR A COMBUSTIONLESS BTU MEASUREMENT METER”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of combustionless measurement of the quality of gaseous fuels fed to gas consumption devices. More particularly, the invention pertains to a method and apparatus for a low cost, high accuracy BTU Meter.

2. Description of Related Art

British Thermal Units (BTU) are a measurement of heat production. The calorific value of a fuel is measured in BTU/cubic foot (CF). The BTU content of gases is directly related to the molecular composition.

The heating value of a substance forms one basis for determining the commercial value of that substance as a fuel. To control fuel flow more efficiently, a system requires accurate and continuous measurements of fuels. By obtaining these measurements, the system provides more uniform and efficient combustion, resulting in better regulation of the heat or power created.

Measuring the quality of gaseous fuels to determine the amount of heat available from them is currently being done for various reasons. In industrial heating processes, it is frequently necessary to feed a well-defined amount of heat per unit of time to a furnace in order to obtain optimum results. In other situations, it is desirable to optimize the consumption of fuel by feeding only the amount of heat actually required.

Methods for evaluating gas quality include combustion calorimetry, as well as combustionless methods. Combustion calorimetry involves the burning of a partial stream of the combustible gas with an open flame or with a catalyst and measuring the heat produced. When burning a measured partial stream of the gas in order to determine its heating value, the apparatus requires frequent maintenance, since combustion residue deposits can change a flame or because the effectiveness of combustion declines over time. As a result, this process must be performed under well-defined, controlled conditions, which makes it expensive.

Combustionless methods for continuously analyzing a stream of gas include gas chromatography and mass spectrometry. These techniques separate and identify each constituent of the gas and measure the relative concentrations. Once the heating value of each constituent of a mixture is known, the total heating value can be calculated. Unfortunately, these methods are complicated and require many measurement and control devices for their use.

Nuclear Magnetic Resonance (NMR) Spectroscopy

NMR is a phenomenon which occurs when the nuclei of certain atoms are immersed in a static magnetic field and exposed to a second radio frequency (RF) electromagnetic field. Some nuclei experience this phenomenon, and others do not, dependent upon whether they possess a property called spin or a magnetic dipole moment.

Nuclei with an odd number of protons, neutrons, or both, will have an intrinsic nuclear spin. When a nucleus with a non-zero spin is placed in a magnetic field, the nuclear spin can align in either the same direction or in the opposite direction as the field. These two nuclear spin alignments have different energies and application of a magnetic field lifts the degeneracy of the nuclear spins. A nucleus that has its spin aligned with the field will have a lower energy than when it has its spin aligned in the opposite direction to the field.

NMR spectroscopy is the absorption of radio frequency radiation by a nucleus in a strong static magnetic (B₀) field. The Larmor frequency is dependent upon the physical properties of the nucleus and the strength B₀ of the magnetic field. The Larmor frequency is shifted by a small amount (ppm) by chemical bonds in compounds. Absorption of radiation causes the nuclear spin to realign or flip in the higher-energy direction. After absorbing energy, the nuclei will re-emit radio frequency radiation of its unique frequency and return to the lower-energy state. The amplitude of emitted free induction decay (FID) energy is proportional to the number of excited nuclei.

The energy of a NMR transition depends on the magnetic-field strength and a proportionality factor for each nucleus called the gyromagnetic ratio. The local environment around a given nucleus in a molecule will slightly perturb the local magnetic field exerted on that nucleus and affect its exact transition energy (chemical shift). This dependence of the transition energy on the position of a particular atom in a molecule makes NMR spectroscopy extremely useful for determining the structure and concentration of molecules.

There have been a number of methods using NMR absorption for BTU analysis patented and described in the past.

U.S. Pat. No. 5,265,635, “CONTROL MEANS AND METHOD FOR CONTROLLING FEED GASES”, Giammatteo et al. (1993), discloses a nuclear magnetic resonance analyzer which analyzes gases and provides a composition signal corresponding to the BTU content of the gas. This patent is concerned primarily with control, not measurement.

U.S. Pat. No. 5,122,746, “HYDROCARBON GAS MEASUREMENTS USING NUCLEAR MAGNETIC RESONANCE”, King et al. (1992), teaches a method of using a NMR response signal to determine calorific content and compressibility. This method determines the calorific value of an unknown hydrogen-bearing gas mixture using a reference gas having a known calorific content. Fourier transform analysis was not used. Therefore, chemical shift molecular signatures were undetected. Inert gases, such as N₂ and C0₂, could not be measured using this method.

U.S. Pat. No. 4,531,093, “METHOD AND APPARATUS FOR COAL ANALYSIS AND FLOW MEASUREMENT”, Rollwitz et al. (1985), discloses a method and apparatus for measuring the heat content of coal. The hydrogen nuclei population of the coal is measured by NMR, while the electron population is measured by electron magnetic resonance. The measurement data is converted into an indication of the heat content, typically measured in BTU.

“MAGNETIC RESONANCE COAL FLOWMETER AND ANALYZER”, King et al., Symposium on Instrumentation and Control for Fossil Energy Processes, Houston, Tex., Jun. 7, 1982, September 1982, p. 30-40, used the electron spin resonance and NMR properties of coal to develop a model of an instrument for measuring the mass flow, calorific value, and several constituents of coal delivered by dense phase gaseous flow through small pipes. The electron and nuclear magnetic resonance data was processed to provide a near real-time readout of the flow velocity, flow density, mass flow rate, calorific value, percent moisture, percent hydrogen and percent carbon for the burnable part of the coal. The mass flow rate and calorific value data were integrated to provide totalized flow and the total delivered heating value in BTU.

None of the prior art is scaled for a battery-powered, unmanned, field deployable, low-cost instrument for natural gas measurement applications. Popular models, due to broad based functionality, require: a) liquid nitrogen and/or liquid helium to cool large electromagnets, b) extensive analog conditioning circuitry, and c) powerful computers.

Therefore, there is a need in the art for an accurate, reliable and inexpensive approach and apparatus for measuring fuel gas quality.

### SUMMARY OF THE INVENTION

A combustionless BTU meter utilizes NMR spectroscopy to measure the mole percentage concentrations of the component parts of a natural gas. Measurement of the gas component concentrations allow for subsequent calculation of heating value in BTU/CF. Static pressure and temperature are also preferably measured. Gas concentrations are preferably combined with static pressure and temperature, to calculate other characteristics of BTU/lb, total molar mass, relative density, and absolute gas density.

In one embodiment of the invention, a combustionless BTU meter contains multiple components. These components preferably include a LCD display, a printed circuit board, and a measurement chamber. The printed circuit board has various parts, preferably including a power supply section, a central processing unit (CPU), a communications interface, an analog measurement section, and a radio frequency and free induction decay signal processing section.

In another embodiment, a method for measuring the BTU/CF of a sample preferably measures CH₄, C₂H₆, C₃H₈, C₄H₁₀, C₅H₁₂, C₆H₁₄, H₂O, C0₂, and N₂ using NMR. Hydrocarbons and water are measured by detecting chemical shift frequencies of ¹H. Neither ¹²C nor ¹⁴N atoms possess a magnetic dipole moment and are not detectable using NMR spectroscopy. CO₂ is measured by detecting the chemical shift frequency of the ¹³C isotope in ¹³C0₂ molecules representing 1.1% of total populations of the normal molecules. The BTU meter also preferably measures N₂ by detecting the chemical shift frequency of the ¹⁵N isotope in N₂ molecules representing 0.366% of total populations of the normal molecules.

### BRIEF DESCRIPTION OF THE DRAWINGS

FIG. 1 shows system components in a preferred embodiment of the invention.

FIG. 2 shows the measurement chamber in a preferred embodiment of the invention.

FIG. 3 shows a typical field installation in a preferred embodiment of the invention.

FIG. 4 shows a block diagram of radio frequency signal processing in a preferred embodiment of the invention.

FIG. 5 shows an example of time domain data prior to transformation.

FIG. 6 shows an example of the Fourier transform transformation.

FIG. 7 shows an example of a Fourier transform of frequency domain data with methane.

FIG. 8 shows an example of a Fourier transform of frequency domain data without methane.

FIG. 9 shows an example of a BTU meter report.

### DETAILED DESCRIPTION OF THE INVENTION

A low cost high accuracy combustionless BTU meter utilizing NMR to measure the concentrations of the component parts of a gas and a method for measuring the heat production of a gas are disclosed. BTU is determined by measuring the gas component concentrations and calculating the BTU from the measured component parts.

As discussed above, none of the prior art is scaled for a battery-powered, unmanned, field deployable, low-cost instrument for natural gas measurement applications. Popular models, due to broad based functionality, require a) liquid nitrogen and/or liquid helium to cool large electromagnets, b) extensive analog conditioning circuitry, and c) powerful computers. The present invention overcomes the shortcomings of the prior art by a) down-scaling for almost all known compositions of natural gas, b) using modem off-the-shelf components, c) limiting the functionality to a dedicated task, d) reducing cost, and e) low power consumption allowing battery-powered instruments.

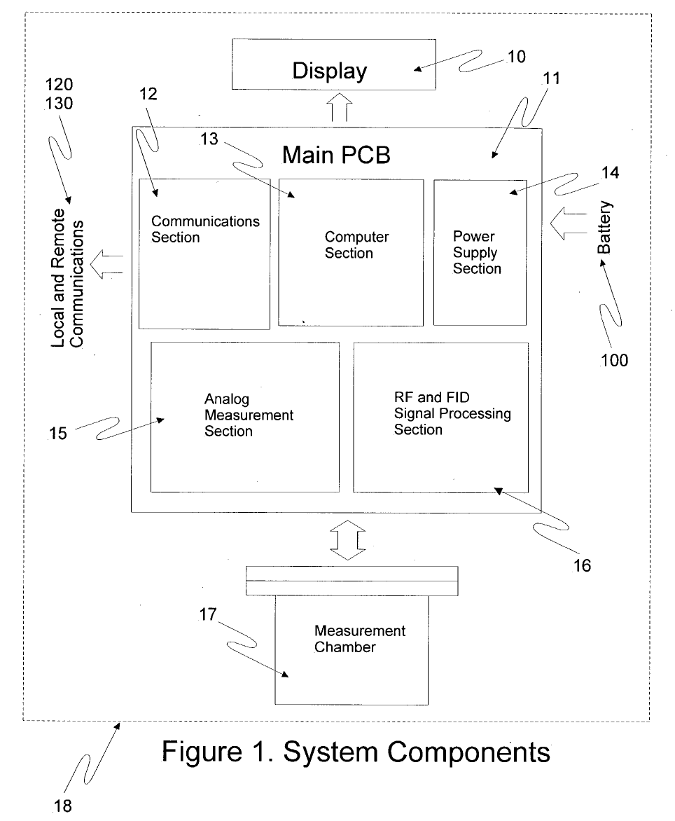

FIG. 1 illustrates major system components of a BTU meter (18) in a preferred embodiment of the invention. A display (10), preferably a LCD display, is connected to the main printed circuit board (PCB) (11). The printed circuit board (11) contains all of the necessary electronic circuitry for control, measurement, data processing, firmware, data storage, and communications to external devices. The power supply section (14) provides power conditioning and regulation.

The low power consumption of the present invention allows for the use of battery powered instruments. The current state-of-the-art of low voltage and low power electronic components has advanced rapidly in recent years. This advance is largely driven by expanding market demands in the field of portable communications devices and other battery powered portable devices. If the meter is being battery operated, the battery (100) is connected to the printed circuit board (11), and provides the apparatus with power.

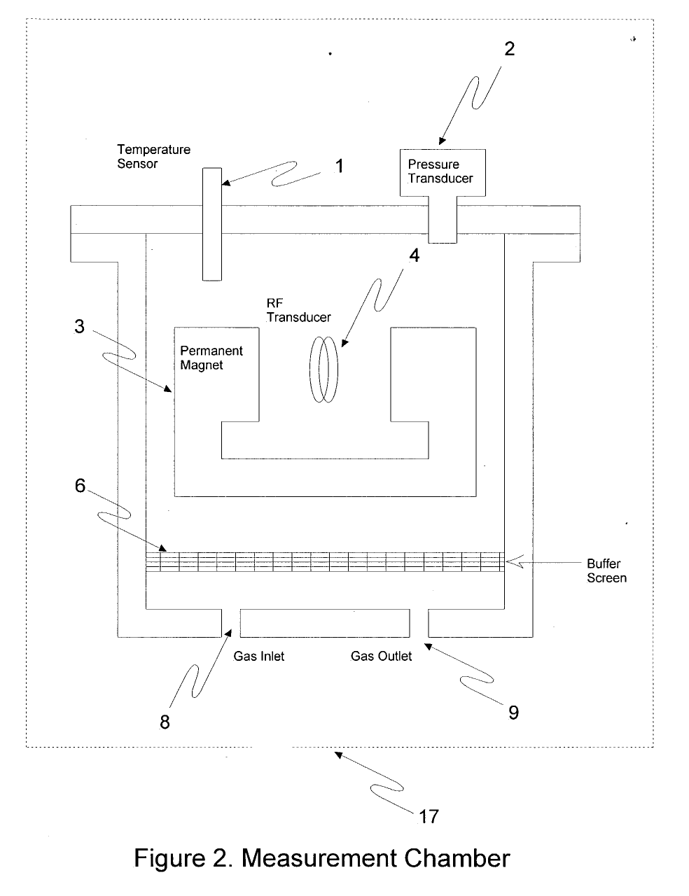

The computer section (13) provides a central processor unit (CPU) core with associated on-chip peripherals, non-volatile memory (ROM), and volatile memory (RAM). The analog measurement section (15) preferably provides signal conditioning of the pressure transducer (2), the temperature sensor (1), the B₀ field flux density, and battery voltage monitoring (see FIG. 2).

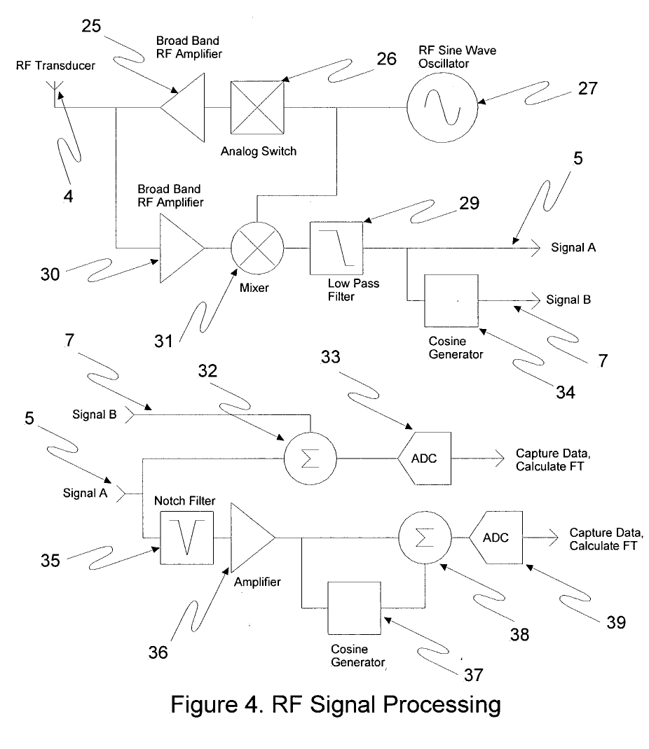

Inexpensive high-speed digital signal processors (DSP), for example the Texas Instruments TMS320C64x series, are preferably utilized. The DSPs are located in the analog measurement section (15). Static voltage measurement is accomplished using an analog to digital converter (ADC), for example Linear Technologies model LTC2413. Two additional analog to digital converters (33) and (39) (see FIG. 4), for example, Analog Devices model AD7663, are preferably utilized for measurement of free induction decay. For B field bias control, a digital to analog converter, for example Analog Devices model AD7545, is preferably used. These converters are all preferably located in the analog measurement section (15). The conditioned signals are presented to the analog to digital converters (ADC) and made available to the central processing unit. The radio frequency and free induction decay signal processing section (16) provides a wide band radio frequency pulse to excite the gas sample, free induction decay signal conditioning, and analog to digital conversion for processing in the central processing unit. The communications section (12) provides a communications interface to external devices. All local (130) and remote communications (120) are controlled by the communications section (12). The printed circuit board (11) is also connected to a measurement chamber (17).

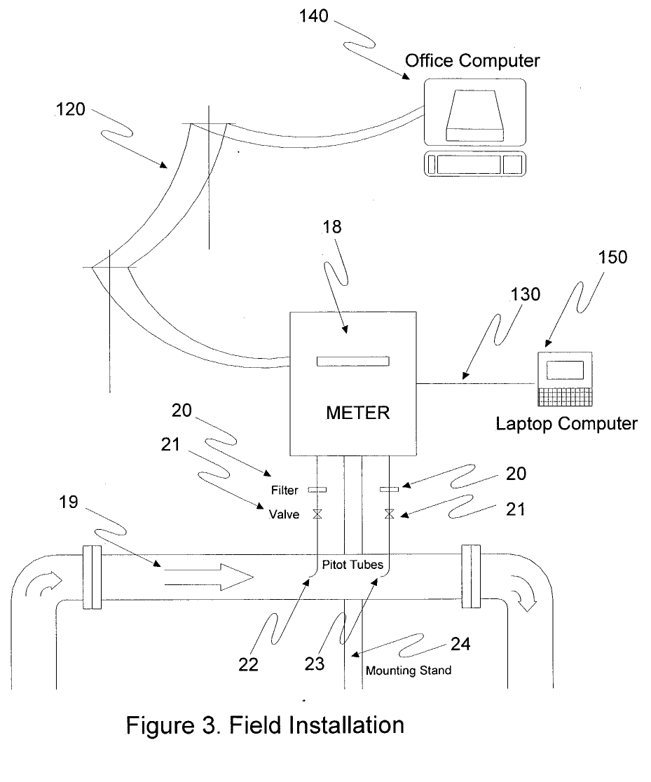

Referring also to FIGS. 2 and 3, the measurement chamber (17) is shown in more detail in FIG. 2. Natural gas flowing in the main pipe (19) is induced by a small pressure differential produced by sampling pitot tubes (22) and (23). The filters (20) and valves (21), although not necessary, are shown to exemplify a typical field installation. The differential induces flow into the gas inlet (8) and out the gas outlet (9). The sample gas permeates through the turbulence buffer screen (6) for measurement. A permanent magnet (3), for example Magnet Sales & Manufacturing Company, model MSD14824, is preferably used to establish the static B₀ field. A radio frequency transducer (4) radiates the pulsed wide band radio frequency energy to align molecular spin of the sample molecules and to absorb the free induction decay signal as spin alignment is lost. A temperature sensor (1), for example the Honeywell TD5A, preferably provides a signal proportional to the sample gas temperature. A pressure transducer (2), for example the Druck PDCR 1000 series transducer, preferably produces a signal proportional to the static pressure of the sample gas.

FIG. 3 illustrates a typical field installation. The mounting stand (24) for the meter (18) is shown to illustrate a typical field installation. The BTU meter is a stand-alone instrument and requires no human interaction in the performance of measurements. Historical logs of periodic measurements stored within the computer section (13) are made available via two different communications channels, remote (120) and direct connect (130). Remote communications (120) allow data gathering and processing by an office computer (140). Direct communications (130) may connect to a laptop computer (150), allowing data to be collected and transported to the office for processing.

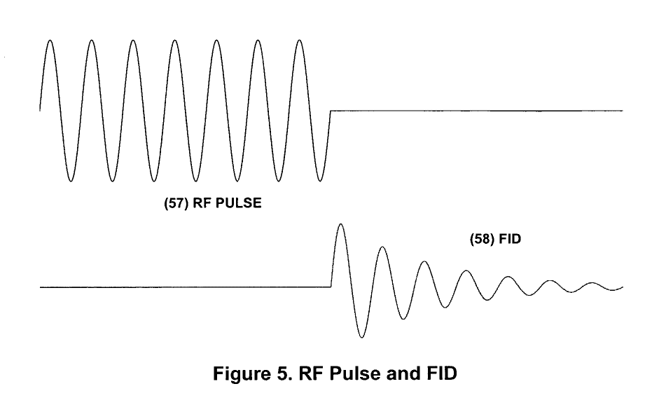

Referring also to FIG. 4, the radio frequency signal processing apparatus and methodology is shown. The components in this figure are all preferably found in the radio frequency and free induction decay signal processing section (16) of the printed circuit board (11). A precision radio frequency sine wave oscillator (27) provides one of three selectable frequencies near the natural absorbance (Larmor) frequency of ¹H, ¹³C, or ¹⁵N. An analog switch (26) is gated on for a precise time, thereby creating a band of frequencies, inclusive of chemical shift frequencies of the molecules being detected, about the center frequency of the oscillator (27). The resultant radio frequency energy band is amplified by a broad band radio frequency amplifier (25) and coupled to the radio frequency transducer (4), located within the measurement chamber (17). The radio frequency transducer (4) radiates the pulsed energy to the gas sample which absorbs the energy producing molecular spin orientation within the B₀ field. Following the excitation radio frequency pulse, the molecular orientation decays back to normal random orientation, emitting radio frequency energy at a very narrow and precise frequency known as the free induction decay signal (see FIG. 5) which is coupled to the input radio frequency amplifier (30). A mixer (31) mixes the signal with the original radio frequency oscillator frequency to produce a low frequency band of frequencies. The low frequency signals are input to a low pass filter (29) to reject higher unwanted frequencies.

The radio frequency Transducer (4) is preferably a coil of wire in the form of a loop antenna. The dimensions and wire size are empirically determined for the desired radio frequency excitation frequency band (Larmor frequency). The Larmor frequency depends on the B₀ field flux density. Therefore, the first step is to select a permanent magnet (3) best suited for the application, settle on a target field strength, and design an radio frequency transducer (4) for the resultant target frequency bands. The radio frequency transducer (4) could be designed by anyone skilled in the art.

Natural gas is composed of approximately 90% methane, so the presence of methane may be assumed in each sample. This eliminates the need of an additional marker, as methane becomes the marker. Markers are traditionally used as a reference to properly calibrate the free induction decay frequencies in samples of unknown composition. Measurement granularity and signal to-noise is greatly enhanced over prior art by adding circuitry to measure the methane in the free induction decay signal by summing up (32) the sine signal A (5) and the cosine signal B (7) into a sine plus cosine signal, which is passed on to the analog to digital converter (33). At the same time, the free induction decay signal is filtered (35) to remove the methane frequency, amplify (36) the remaining signal by a factor of approximately 10, and measure the frequencies of the other gas components. The output of the summation (38) is a sine plus cosine signal which is passed on to an analog to digital converter (39). This provides enhanced signal-to-noise ratios and increases granularity of measurement of the remaining hydrocarbons. In so doing, signal processing circuitry is greatly simplified, as compared to other methods used in prior art.

Three measurements are required to detect ¹H, ¹³C, or ¹⁵N molecules. In the case of ¹H bonded hydrocarbon molecules found in natural gas, the free induction decay signal is composed of a combination of the chemical shifted frequencies of each of the hydrocarbon molecules. For ¹³C, the chemical shift frequency of ¹³CO₂ is emitted. For ¹⁵N, the chemical shift frequency of ¹⁵N₂ is emitted. The radio frequency transducer (4) absorbs the free induction decay signal which is coupled to the input radio frequency amplifier (30). A mixer (31) mixes the signal with the original radio frequency oscillator frequency to produce a low frequency band of frequencies. The low frequency signal is input to a low pass filter (29) to reject higher unwanted frequencies. The output of this process is Signal A (5). This sine signal is added (32) to Signal B (7), a cosine signal produced by a cosine generator (34). The resulting sine plus cosine signal is input into an analog to digital converter (33) for conversion to digital data points. It is then passed to the central processing unit in the computer section (13) for storage and analysis using a Fourier transform to convert the time domain data to frequency domain.

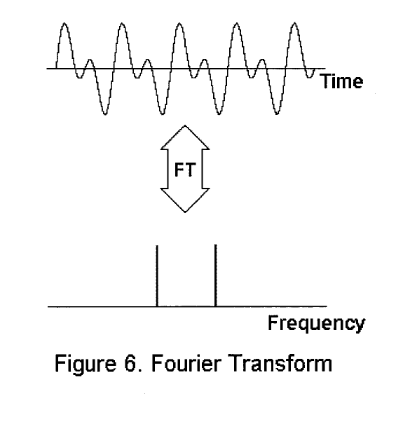

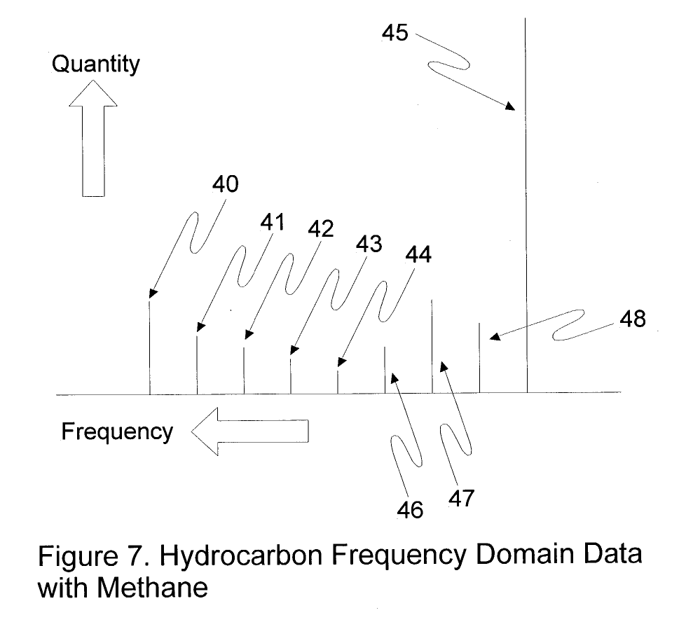

Further signal processing is required when measuring ¹H hydrocarbon molecules. Signal A (5) is passed through a band reject filter (35), removing the chemical shift frequency of methane ((45) in FIG. 7) from the free induction decay signal, leaving only other hydrocarbon frequencies. Approximately 90% of the original amplitude, the methane frequency, is removed in the filtered free induction decay. An amplifier (36) with a Vₒᵤₜ/Vᵢₙ gain of approximately 10 restores signal amplitudes. The sine signal is added (38) to a cosine signal produced by a cosine generator (37) and input to an analog to digital converter (39) for conversion to digital data points in the radio frequency and free induction decay signal processing section (16). The digital data points are then passed to the central processing unit in the computer section (13) for storage. Analysis is performed using Fourier transform, which converts the time domain data to frequency domain data (see FIG. 6).

A FT is defined by the integral:

$$S ( f ) = {\int }_{- ∞}^{+ ∞} s ( t ) {ⅇ}^{- j2π ft} ⅆ t$$

(E. O. Brigham The Fast Fourier Transform and its applications Prentice-Hall, Upper Saddle River, N.J. 1988, pp. 4-5).

The BTU meter preferably measures CH₄, C₂H₆, C₃H₈, C₄H₁₀, C₅H₁₂, C₆H₁₄, H₂O, C0₂, and N₂. Hydrocarbons and water are measured by detecting chemical shift frequencies of ¹H. Neither normal carbon (¹²C) nor normal nitrogen (¹⁴N) atoms possess a magnetic dipole moment and are not detectable using NMR spectroscopy. CO₂ is measured by detecting the chemical shift frequency of the ¹³C isotope in ¹³C0₂ molecules representing 1.1% of total populations of the normal molecules. The BTU meter also measures N₂ is measured by detecting the chemical shift frequency of the ¹⁵N isotope in N₂ molecules representing 0.366% of total populations of the normal molecules.

The actual Fourier transformation of the time domain data to frequency domain data algorithm is understood by one skilled in the art of mathematics. FIG. 5 illustrates the radio frequency pulse (57) and the free induction decay signal (58) of the time domain data. FIG. 6 illustrates the transformation. The analog to digital converter (33) produces free induction decay data for a sample with methane, which is then transformed into frequency domain data in FIG. 7. The height of the vertical spectral lines indicate relative quantities of methane (CH₄) (45), ethane (C₂H₆) (48), propane (C₃H₈) (47), isobutane (C₄H₁₀) (46), butane (C₄H₁₀) (44), dimethylpropane (C₅H₁₂) (43), isopentane (C₅H₁₂) (42), pentane (C₅H₁₂) (41), and water (H₂0) (40).

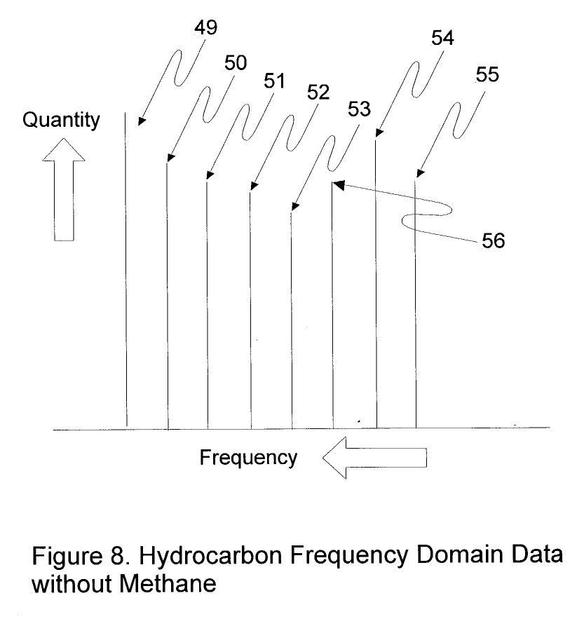

The analog to digital converter (39) produces free induction decay data for a sample after the methane has been filtered out. That data is then transformed into frequency domain data in FIG. 8. The height of the vertical spectral lines indicate relative quantities, without methane, of ethane (C₂H₆) (55), propane (C₃H₈) (54), isobutane (C₄H₁₀) (56), butane (C₄H₁₀) (53), dimethylpropane (C₅H₁₂) (52), isopentane (C₅H₁₂) (51), pentane (C₅H₁₂) (50), and water (H₂0) (49).

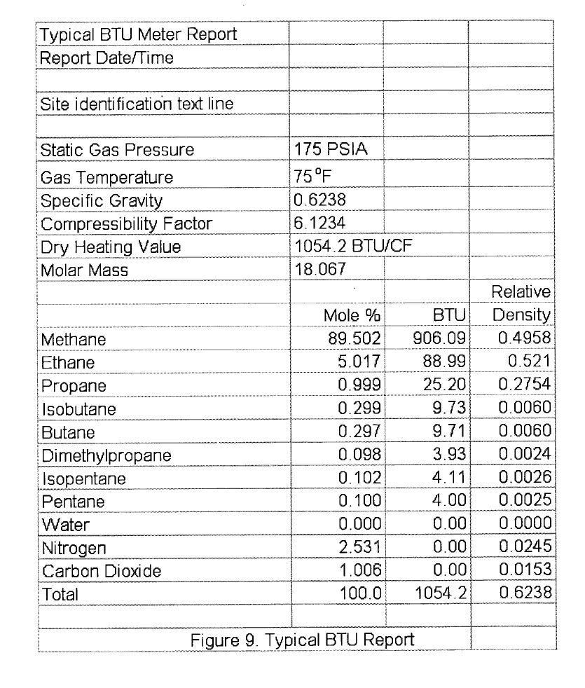

Referring back to FIG. 3, one form of processing may be the creation of reports. An example of a measurement report might include the information shown in FIG. 9, a typical BTU meter report. The static gas pressure in this example is 175 PSIA and the gas temperature is 75° F. The specific gravity of the sample is 0.6238, and the molar mass is 18.067. The dry heating value is 1054.2 BTU/CF. Each of the molecules is represented as a mole percentage of the whole. For example, methane is present at 89.502%. The BTU of methane in this sample is 906.09, and the relative density is 0.4958.

The present invention limits the functionality to a dedicated task to reduce complexity and cost. Prior art utilized a broad range of functionality at a commensurate cost of hardware and electronic circuitry. The dedicated functionality of the suggested apparatus and methodology minimizes the diversity of hardware and electronic circuitry.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of measuring a heat capacity of a gas comprising the steps of:
a) measuring a mole percentage concentration of at least one component part of a gas sample wherein this step is accomplished using nuclear magnetic resonance spectroscopy; and
b) calculating a heating value of said gas sample using said mole percentage concentrations measured in step (a).

2. The method of claim 1, wherein said heating value is calculated in British Thermal Units per cubic foot.

3. The method of claim 1, wherein said component part is selected from the group consisting of:
a) CH₄;
b) C₂H₆;
c) C₃H₈;
d) C₄H₁₀;
e) C₅H₁₂;
e) C₆H₁₄;
f) H₂O;
g) C0₂; and
h) N₂.

4. The method of claim 1, further comprising the steps of:
c) measuring a static pressure of said gas sample; and
d) measuring a temperature of said gas sample.

5. The method of claim 4, further comprising the step of:
e) calculating at least one additional characteristic of said gas sample using said temperature, said static pressure, and said mole percentage concentration.

6. The method of claim 5, wherein said additional characteristic is selected from the group consisting of:
a) British Thermal Units per pound;
b) total molar mass;
c) relative density; and
d) absolute gas density.

7. The method of claim 1, wherein step (a) comprises the substep of:
i) radiating a pulsed energy to the gas sample with a radio frequency transducer within a measurement chamber, thereby creating a free induction decay signal when a molecular orientation decays back to normal.

8. The method of claim 7, wherein step (a) further comprises the substep of:
ii) measuring a chemical shift frequency of a ¹³C isotope in the free induction decay signal using a first analog to digital converter;
wherein said ¹³C isotope represents approximately 1.1% of a total population of CO₂ molecules.

9. The method of claim 8, wherein step (a) further comprises the substep of:
iii) calculating a mole percentage concentration of CO₂ in the gas sample.

10. The method of claim 7, wherein step (a) further comprises the substep of:
ii) measuring a chemical shift frequency of a ¹⁵N isotope in the free induction decay signal using a first analog to digital converter;
wherein said ¹⁵N isotope represents approximately 0.366% of a total population of N₂ molecules.

11. The method of claim 10, wherein step (a) further comprises the substep of:
iii) calculating a mole percentage concentration of N₂ in the gas sample.

12. The method of claim 7, wherein step (a) further comprises the substep of:
ii) measuring a methane frequency in the free induction decay signal using a first analog to digital converter.

13. The method of claim 12, wherein step (a) further comprises the substeps of:
iii) filtering said free induction decay signal to remove the methane frequency;
iv) amplifying the free induction decay signal; and
v) measuring a frequency of at least one hydrocarbon component using a second analog to digital converter.

14. The method of claim 13, wherein substep (a) further comprises the substeps of:
vi) converting the free induction decay signal into a plurality of digital data points; and
vii) performing a Fourier transform analysis on said digital data points created in step (vi).

15. The method of claim 7, wherein step (a) further comprises, prior to substep (i), the substeps of:
ii) providing a selectable frequency of at least one molecule, wherein said selectable frequency is provided using a radio frequency sine wave oscillator;
iii) gating an analog switch for a precise time, wherein gating creates a band of frequencies about a center frequency of said sine wave oscillator; and
iv) amplifying a radio frequency energy band by a radio frequency amplifier coupled to said radio frequency transducer;

16. An apparatus for measuring a heat capacity of a gas comprising:
a) a printed circuit board; and
b) a measurement chamber connected to said printed circuit board, wherein said measurement chamber measures a mole percentage concentration of at least one component part of a gas sample using nuclear magnetic resonance spectroscopy.

17. The apparatus of claim 16, wherein said component part is selected from the group consisting of:
a) CH₄;
b) C₂H₆;
c) C₃H₈;
d) C₄H₁₀;
e) C₅H₁₂;
e) C₆H₁₄;
f) H₂O;
g) C0₂; and
h) N₂.

18. The apparatus of claim 16, wherein said apparatus further comprises a display, wherein said display is connected to said printed circuit board.

19. The apparatus of claim 16, wherein said apparatus further comprises a battery connected to said printed circuit board.

20. The apparatus of claim 16, wherein said measurement chamber comprises:
a) a permanent magnet, wherein said magnet establishes a static B₀ field; and
b) a radio frequency transducer, wherein said radio frequency transducer radiates a pulsed wide band radio frequency energy to align a molecular spin of said gas sample and absorb a free induction decay signal.

21. The apparatus of claim 20, wherein said measurement chamber further comprises:
c) a gas inlet and a gas outlet for said gas sample to flow into and out of said measurement chamber;
d) at least one sampling pitot tube to induce flow with a small pressure differential; and
e) a buffer screen, wherein said gas sample permeates through said buffer screen.

22. The apparatus of claim 20, wherein said measurement chamber further comprises:
c) a temperature sensor, wherein said temperature sensor provides a signal proportional to a sample gas temperature; and
d) a pressure transducer, wherein said pressure transducer produces a signal proportional to a static pressure of the sample gas.

23. The apparatus of claim 20, wherein said printed circuit board comprises:
a) a power supply section;
b) a computer section, wherein said computer section comprises a central processing unit;
c) a communications interface;
d) an analog measurement section; and
e) a radio frequency and free induction signal processing section.

24. The apparatus of claim 23, wherein said radio frequency and free induction decay section comprises:
a) a broad band radio frequency amplifier, wherein said broad band radio frequency amplifier is connected to said radio frequency transducer;
b) a mixer, wherein said mixer mixes the signal with an original radio frequency oscillator frequency to produce a low frequency band of frequencies;
c) a low pass filter, wherein said low pass filter receives the signal from the mixer and creates a sine signal;
d) a cosine generator, wherein said cosine generator produces a first cosine signal;
e) means for summing up said sine signal and said first cosine signal to create a sine plus cosine signal; and
f) a first analog to digital converter, wherein said first analog to digital converter measures said component part in the free induction decay signal and converts the free induction decay signal into a plurality of digital data points;
wherein said digital data points created from the first analog to digital converter are passed to the central processing unit for storage.

25. The apparatus of claim 24, wherein said radio frequency and free induction decay section further comprises:
g) a radio frequency sine wave oscillator, wherein said sine wave oscillator provides one of three selectable frequencies near a natural absorbance frequency of the group consisting of ¹H, ¹³C, or ¹⁵N; and
h) an analog switch, wherein said analog switch is gated on for a precise time, thereby creating a band of frequencies about a center frequency of said sine wave oscillator.

26. The apparatus of claim 24, wherein said digital data points are converted into frequency domain data using a Fourier transform.

27. The apparatus of claim 24, wherein said radio frequency and free induction decay section further comprises:
g) a band reject filter, wherein said free induction decay signal passes through said band reject filter to remove the chemical shift frequency of methane from the free induction decay signal, leaving only other hydrocarbon frequencies; and
h) an amplifier, wherein said amplifier amplifies the free induction decay signal by approximately tenfold;
wherein said free induction decay signal is added to a second cosine signal and input into a second analog to digital converter for conversion to a plurality of digital data points;
wherein these additional components of the apparatus are needed when measuring ¹H hydrocarbon molecules.

28. The apparatus of claim 27, wherein said digital data points are passed to the central processing unit for storage.

29. The apparatus of claim 28, wherein said digital data points are converted into frequency domain data using a Fourier transform.
